(19) United States
(12) Patent Application Publication
(10) Pub. No.: US 2016/0361669 A1
(43) Pub. Date: Dec. 15, 2016

(54) SLUDGE DISCHARGING DEVICE FOR SETTLEMENT BASIN

(71) Applicant: Jong hyung HUR, Ulsan (KR)

(72) Inventor: Jong hyung HUR, Ulsan (KR)

(21) Appl. No.: 15/109,720

(22) PCT Filed: Dec. 17, 2014
(86) PCT No.: PCT/KR2014/012436

§ 371 Date: Jul. 5, 2016

(30) Foreign Application Priority Data
Dec. 31, 2013 (KR) 10-2013-0168395

(51) Int. Cl. B01D 21/24; B01D 21/00; B01D 21/02

(52) U.S. Cl. CPC B01D 21/2472; B01D 21/02; B01D 21/0033; B01D 21/0024

(57) ABSTRACT

The present sludge discharging system for a settlement basin may have the partition portion between the sludge conveying region and sludge discharging region on the bottom of the settlement basin. The first pressurized water ejection assembly may move the sludge from the sludge conveying region to the sludge discharging region. The second pressurized water ejection assembly may move the sludge from the sludge discharging region to the discharging port out of the settlement basin. The separation-water ejection assembly may form a separation water wall above the partition portion to suppress the back-flow of the sludge to the sludge conveying region during the second pressurized water ejection assembly moves the sludge to the discharging port. This may achieve a reliable sludge discharging operation.

### BACKGROUND

Field of the Present Disclosure

The present disclosure relates to a sludge discharging system for a settlement basin. More particularly, the present disclosure relates to a sludge discharging system for a settlement basin in a water purification plant or waste water treatment plant to eject a pressurized water to a sludge settled on a bottom of the settlement basin to move the sludge out of the basin.

Discussion of the Related Art

Generally, in a settlement basin, suspended substances are agglomerated using a coagulant and then are settled due to a specific gravity difference over time to form a sludge on a bottom of the basin. The settled sludge may be collected to a front bottom side of the basin using an underwater carrier 2 to 6 times per one day. Then, the collected sludge may be stored in a sludge hopper.

However, agglomerated suspended substances in the settlement basin may have good subsidence such that most of suspended substances may be settled until a ⅔ portion of the settlement basin. Thus, in a rear side of the settlement basin, the settled sludge amount may be smaller. The underwater carrier may play an insignificant role in moving the sludge into the sludge hopper at the front side of the settlement basin.

Further, in a rear end of the settlement basin, there is a dead-area in which the underwater carrier may not reach due to an inherent structure of the carrier. Thus, in the dead-area, a small amount of the sludge may gradually and continuously accumulate thereon, to lead to the sludge float due to the sludge corruption. The floated sludge may deteriorate a water quality and impose a working load during the settlement basin post-treatment.

In order to solve the above problems, the present applicant discloses Korea patent number 10-1046315 (Jun. 28, 2011) in which a pressurized water may be ejected to the sludge which may be moved out of the basin. In this connection, the pressurized water may move the sludge to the discharging port and, in turn, the discharging port may be opened and then the pressurized water may be again ejected toward the discharging port to move the sludge out of the basin.

However, in the above document, when the pressurized water is ejected to the collected sludge adjacent to the discharging port, the sludge may be dispersed due to the pressure force of the pressurized water and may move to the rear side of the basin. This may have a limitation in discharging the sludge.

### SUMMARY

The present disclosure provides a sludge discharging system for a settlement basin to prevent a back-flow of the sludge during discharging the sludge via the discharging port using the pressurized water, thereby to achieve a reliable sludge discharging operation.

In one aspect, there is provided a sludge discharging system for a settlement basin, the system comprising: a settlement basin having a partition portion upwardly protruded on a bottom thereof, wherein the partition portion dividing the settlement basin into a sludge conveying region and a sludge discharging region, wherein the settlement basin has a discharging port defined at one side wall thereof in the sludge discharging region; a first pressurized water ejection assembly having a water ejection portion adjacent to a bottom of the basin in the sludge conveying region to eject a first pressurized water to a sludge on the bottom of the basin in the sludge conveying region to move the sludge from the sludge conveying region to the sludge discharging region; a second pressurized water ejection assembly having a water ejection portion adjacent to a bottom of the basin in the sludge discharging region to eject a second pressurized water to a sludge on the bottom of the basin in the sludge discharging region to move the sludge to the discharging port; and a separation-water ejection assembly having a water ejection portion disposed above the partition portion to eject a third pressurized water toward the partition portion when the sludge in the sludge discharging region is discharged to the port using the second pressurized water ejection assembly, wherein the ejection of the third pressurized water forms a separation water wall between the sludge conveying region and the sludge discharging region, to prevent a back-flow of the sludge from the sludge discharging region to the sludge conveying region.

In one embodiment, the first pressurized water ejection assembly includes: a first pump; a first pressurized water supply-line fluid-coupled to the first pump to receive the first pressurized water pressurized using the first pump; first pressurized water distribution-lines, each line having one end fluid-coupled to the first pressurized water supply-line, the other ends of the first pressurized water distribution-lines being horizontally spacedly arranged on the bottom of the basin in the sludge conveying region; and first primary ejection-nozzles fluid-coupled to each of the first pressurized water distribution-lines, the first ejection-nozzles being spacedly arranged from each other in a longitudinal direction of the other end of each first pressurized water distribution-line, wherein the first ejection-nozzles eject the first pressurized water toward the sludge discharging region to move the sludge to the sludge discharging region.

In one embodiment, the first pressurized water ejection assembly further includes: a first adjustment valve coupled to one end of each of the first pressurized water distribution-lines; and a first back pressure delay valve coupled to one end of each of the first pressurized water distribution-lines so as to bypass the first adjustment valve.

In one embodiment, the first ejection-nozzles are arranged horizontally on the bottom of the basin in the sludge conveying region, wherein the first assembly further includes first auxiliary ejection-nozzles fluid-coupled to each of the first pressurized water distribution-lines, the first auxiliary ejection-nozzles being horizontally spacedly arranged from each other in a longitudinal direction of the other end of each first pressurized water distribution-line, wherein the first auxiliary ejection-nozzles are disposed under the first primary ejection-nozzles.

In one embodiment, the first auxiliary ejection-nozzles are alternated in a position with the first ejection-nozzles.

In one embodiment, the second pressurized water ejection assembly includes: a second pump; a second pressurized water supply-line fluid-coupled to the second pump to receive the second pressurized water pressurized using the second pump; second pressurized water distribution-lines, each line having one end fluid-coupled to the second pressurized water supply-line, the other ends of the second pressurized water distribution-lines being horizontally spacedly arranged on the bottom of the basin in the sludge discharging region; and second primary ejection-nozzles fluid-coupled to each of the second pressurized water distribution-lines, the second ejection-nozzles being spacedly arranged from each other in a longitudinal direction of the other end of each second pressurized water distribution-line, wherein the second ejection-nozzles eject the second pressurized water toward the discharging port to move the sludge to the discharging port.

In one embodiment, the second pressurized water ejection assembly further includes: a second adjustment valve coupled to one end of each of the second pressurized water distribution-lines; and a second back pressure delay valve coupled to one end of each of the second pressurized water distribution-lines so as to bypass the second adjustment valve.

In one embodiment, the second ejection-nozzles are arranged horizontally on the bottom of the basin in the sludge discharging region, wherein the second assembly further includes second auxiliary ejection-nozzles fluid-coupled to each of the second pressurized water distribution-lines, the second auxiliary ejection-nozzles being horizontally spacedly arranged from each other in a longitudinal direction of the other end of each second pressurized water distribution-line, wherein the second auxiliary ejection-nozzles are disposed under the second primary ejection-nozzles.

In one embodiment, the second auxiliary ejection-nozzles are alternated in a position with the second ejection-nozzles.

In one embodiment, the separation-water ejection assembly includes: a third pump; a third pressurized water supply-line fluid-coupled to the third pump to receive the third pressurized water pressurized using the third pump; a third pressurized water distribution-line parallel to the partition portion and disposed above the partition portion at a predetermined distance, the third pressurized water distribution-line having one end fluid-coupled to the third pressurized water supply-line; and third ejection-nozzles fluid-coupled to the third pressurized water distribution-line and spacedly arranged from each other along a longitudinal direction of the third pressurized water distribution-line, wherein the third ejection-nozzles eject the third pressurized water toward the partition portion to form the separation water wall between the sludge conveying region and the sludge discharging region.

In one embodiment, the third pressurized water ejection assembly further includes: a third adjustment valve coupled to one end of the third pressurized water distribution-line; and a third back pressure delay valve coupled to one end of the third pressurized water distribution-line so as to bypass the third adjustment valve.

In one embodiment, the partition portion has a triangular cross section shape, wherein the partition portion has an apex, a first tilt angle from a horizontal plane tangential to the apex to a first side face of the partition portion toward the sludge discharging region, and a second tilt angle from the horizontal plane tangential to the apex to a second side face of the partition portion toward the sludge conveying region wherein the first tilt angle is larger than the second tilt angle.

In one embodiment, the second side face of the partition portion toward the sludge conveying region is rounded.

In one embodiment, the system further comprises a flow guide plate provided at one or more of four inner bottom corners of the basin in the sludge conveying region, wherein the flow guide plate has a concavely rounded top face; and a dead-area ejection assembly fluid-coupled to the first pressurized water ejection assembly to eject the first pressurized water to the flow guide plate.

In one embodiment, the dead-area ejection assembly includes: a fourth water supply-line having one end fluid-coupled to the first pressurized water ejection assembly and the other end coupled to a side wall of the settlement basin in the sludge conveying region and disposed above the flow guide plate; and fourth water ejection-nozzles spacedly arranged from each other along the fourth water supply-line in a longitudinal direction thereof, wherein the fourth water ejection-nozzles eject the first pressurized water from the first pressurized water ejection assembly to the flow guide plate to move the sludge on the inner bottom corner of the basin in the sludge conveying region to the sludge discharging region.

The present sludge discharging system for a settlement basin may have the partition portion between the sludge conveying region and sludge discharging region on the bottom of the settlement basin. The first pressurized water ejection assembly may move the sludge from the sludge conveying region to the sludge discharging region. The second pressurized water ejection assembly may move the sludge from the sludge discharging region to the discharging port out of the settlement basin. In this connection, the separation-water ejection assembly may form a separation water wall above the partition portion to suppress the back-flow of the sludge to the sludge conveying region during the second pressurized water ejection assembly moves the sludge to the discharging port. This may achieve a reliable sludge discharging operation.

### BRIEF DESCRIPTIONS OF THE DRAWINGS

FIG. 1 shows a perspective view of a schematic configuration of a sludge discharging system for a settlement basin in accordance with one embodiment of the present disclosure.

FIG. 2 shows a schematic side view of the apparatus in FIG. 1.

### DETAILED DESCRIPTIONS

Hereinafter, embodiments of the present disclosure will be described in details with reference to attached drawings.

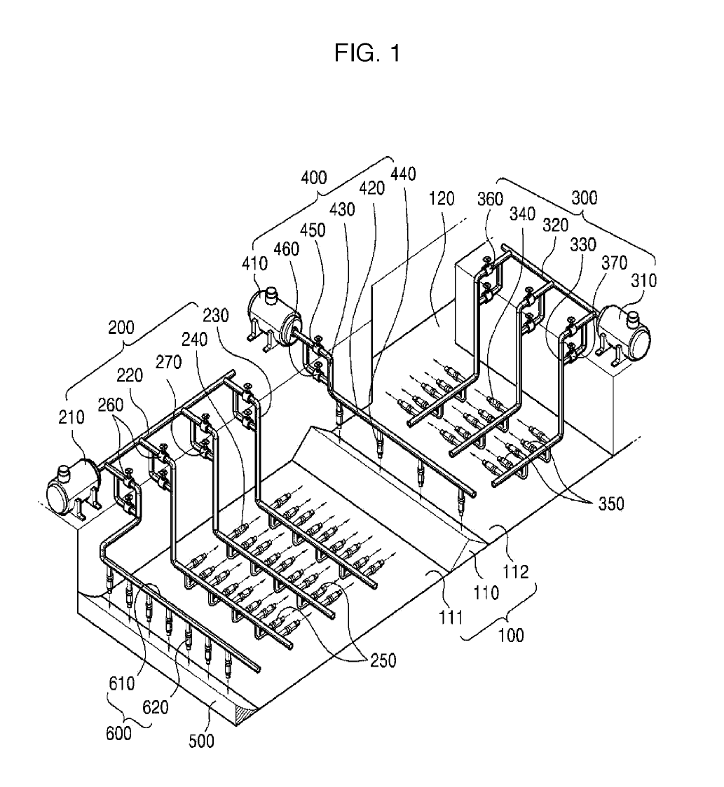

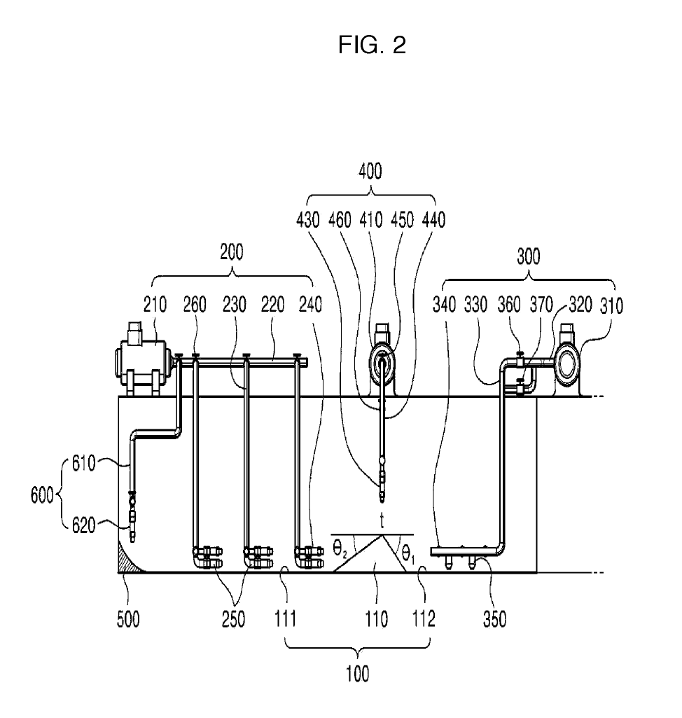

FIG. 1 shows a perspective view of a schematic configuration of a sludge discharging system for a settlement basin in accordance with one embodiment of the present disclosure. FIG. 2 shows a schematic side view of the apparatus in FIG. 1. Referring to FIG. 1 and FIG. 2, the sludge discharging system for a settlement basin may include a settlement basin 100, a first pressurized water ejection assembly 200, a second pressurized water ejection assembly 300, and a separation-water ejection assembly 400.

The settlement basin 100 may have a settlement location in which suspended substances in waters in a water purification plant or waste water treatment plant are agglomerated and settled over time such that a sludge is stacked on a bottom thereof. The settlement basin 100 may typically have a cylindrical structure with an open top. The present disclosure may not be limited thereto. For example, the settlement basin 100 may have a rectangular or polygonal hollow structure with an open top. The settlement basin 100 may typically have a flat bottom. The present disclosure may not be limited thereto. For example, the settlement basin 100 may have a tilted bottom in one direction or opposite two directions relative to a center thereof.

At one side of the settlement basin 100, a discharging port 120 as will be described below may be defined through which a sludge conveyed by the first pressurized water ejection assembly 200 and second pressurized water ejection assembly 300 is discharged out of the settlement basin 100. Specifically, the discharging port 120 may pass through the settlement basin 100 at one side of a sludge discharging region 112 of the settlement basin 100, and thus may allow the sludge in the sludge discharging region 112 by a pressurized water ejected from the second pressurized water ejection assembly 300 to be discharged out of the settlement basin 100.

Further, on a bottom of the settlement basin 100, a partition portion 110 may be formed to protrude from the bottom upwardly in a triangular cross section shape. The cross section shape of the partition portion 110 may not be limited thereto. For example, the cross section shape of the partition portion 110 may be rounded at an outer face thereof. The partition portion 110 may be configured to divide the bottom of the settlement basin 100 into the sludge conveying region 111 and sludge discharging region 112 and physically separate the sludge conveying region 111 and sludge discharging region 112 from each other. Specifically, the partition portion 110 may be integrated into the bottom of the settlement basin 100 to be disposed between front and rear ends of an inner wall of the settlement basin 100.

In this connection, the sludge on the bottom of the sludge conveying region 111 may be transferred to the sludge discharging region 112 by the pressurized water ejected from the first pressurized water ejection assembly 200 as will be described later. Then, the sludge on a bottom of the sludge discharging region 112 may be transferred to the discharging port 120 of the settlement basin 100 by the pressurized water ejected from the second pressurized water ejection assembly 300 as will be described later.

As described above, the partition portion 110 may be formed to protrude from the bottom upwardly in a triangular cross section shape. In this connection, the partition portion 110 may have an apex t, a tilt angle θ₁ from a horizontal plane tangential to the apex t to a first side face of the portion 110 toward the sludge discharging region 112 and a tilt angle θ₂ from a horizontal plane tangential to the apex t to a second side face of the portion 110 toward the sludge conveying region 111 wherein the tilt angle θ₁ is larger than the tilt angle θ₂. In this way, since the tilt angle θ₁ is larger than the tilt angle θ₂, the sludge transfer from the sludge conveying region 111 to the sludge discharging region 112 may be easily realized, while the sludge back-flow from the sludge discharging region 112 to the sludge conveying region 111 may be suppressed. Further, the separation-water ejection assembly 400 as will be described later may eject a pressurized water toward the apex of the partition portion 110 to generate a separation water between the sludge discharging region 112 and the sludge conveying region 111 to prevent the back-flow of the sludge. In this connection, the side face of the partition portion 110 from the apex thereof to the sludge conveying region 111 may be rounded to facilitate the sludge transfer from the sludge conveying region 111 to the sludge discharging region 112 using the pressurized water ejected from the first pressurized water ejection assembly 200 as will be described later.

The first pressurized water ejection assembly 200 and the second pressurized water ejection assembly 300 may jointly allow the sludge settled on the bottom of the settlement basin 100 to be discharged via the discharging port 120 out of the settlement basin 100.

The first pressurized water ejection assembly 200 may have one end adjacent to the bottom of the sludge conveying region 111 of the settlement basin 100 to push the sludge on the bottom of the sludge conveying region 111 using the pressurized water ejected therefrom toward the bottom of the sludge discharging region 112 of the settlement basin 100. In this connection, the first pressurized water ejection assembly 200 may include a first pump 210, a first pressurized water supply-line 220, first pressurized water distribution-lines 230, and first primary ejection-nozzles 240.

The first pump 210 may be configured to generate a conveying pressure to supply the pressurized water from an external water storage to the first pressurized water supply-line 220 wherein the pressurized water may be ejected toward the bottom of the settlement basin 100, more preferably, to the bottom of the sludge conveying region 111 thereof. The first pump 210 may be provided at one side of the settlement basin 100 and may be fluid-coupled to the first pressurized water supply-line 220. In this connection, the first pump 210 may be fixedly provided outside of the settlement basin 100 or may be lifted or lowered from or to a surface of the water in the settlement basin 100. In this connection, when the first pump 210 is activated, the water to supplied to the first pressurized water supply-line 220 may be embodied as a separate water from an external storage or as an upper water in the settlement basin 100.

The first pressurized water supply-line 220 may be configured to supply the pressurized water using the first pump 210 to the first pressurized water distribution-lines 230. The first pressurized water supply-line 220 may have one end coupled to an outlet of the first pump 210, and outlets coupled to inlets of the first pressurized water distribution-lines 230.

The first pressurized water distribution-lines 230 may be branched from the first pressurized water supply-line 220 to supply the pressurized water from the first pressurized water supply-line 220 into the settlement basin 100. Specifically, each of the first pressurized water distribution-lines 230 may have one longitudinal end coupled to the other end of the first pressurized water supply-line 220. The other longitudinal ends of the first pressurized water distribution-lines 230 may be arranged to be spaced from each other on the bottom of the sludge conveying region 111 of the settlement basin 100. In this connection, the first pressurized water distribution-lines 230 may be branched from the first pressurized water supply-line 220 in a longitudinal direction thereof such that the first pressurized water distribution-lines 230 may be spaced from each other at a constant distance. In this connection, the first pressurized water distribution-lines 230 may have respectively the other longitudinal ends which may be spaced from each other at a constant distance on the bottom of the sludge conveying region 111 of the settlement basin 100. The present disclosure may not be limited thereto. The other longitudinal ends may be disposed on the side wall of the sludge conveying region 111. The other longitudinal ends may be disposed distant from the on the bottom of the sludge conveying region 111 of the settlement basin 100. The first pressurized water distribution-lines 230 may be buried in the bottom or side wall of the sludge conveying region 111 of the settlement basin 100 such that tip portions of the first primary ejection-nozzles 240 may protrude out of the bottom of the settlement basin 100 into the settlement basin 100. Additionally, each of the first pressurized water distribution-lines 230 may have a first adjustment valve 260 at one end thereof to control a fluid flow from the first pressurized water supply-line 220 to each of the first primary ejection-nozzles 240. Further, each of the first pressurized water distribution-lines 230 may have a first back pressure delay valve 270 at one end thereof configured not to stop the ejection of the pressurized water from the first primary ejection-nozzles 240 immediately after the first adjustment valve 260 is closed, but to be closed in a given time after the first adjustment valve 260 is closed to prevent the back-flow of the sludge via the first primary ejection-nozzles 240. Each of the first back pressure delay valves 270 may bypass the first adjustment valve 260 along each of the first pressurized water distribution-lines 230.

The first primary ejection-nozzles 240 may be configured to eject the pressurized water from the first pressurized water distribution-lines 230 to the bottom of the settlement basin 100, more preferably, to the bottom of the sludge conveying region 111 thereof to allow the sludge from the bottom of the sludge conveying region 111 to the sludge discharging region 112. The first primary ejection-nozzles 240 may be spacedly arranged along each of the first pressurized water distribution-lines 230. In this connection, the tip portions of the first primary ejection-nozzles 240 may be oriented toward the sludge discharging region 112 to eject the pressurized water toward the sludge discharging region 112. The first primary ejection-nozzles 240 may extend horizontally on the bottom of the sludge conveying region 111 and may be fluid-coupled to each of the first pressurized water distribution-lines 230. Thus, when the first primary ejection-nozzles 240 eject the pressurized water, the sludge on the bottom of the sludge conveying region 111 of the settlement basin 100 may be transferred to the sludge discharging region 112.

The first pressurized water ejection assembly 200 may further include a plurality of first auxiliary ejection-nozzles 250 fluid-coupled to each of the first pressurized water distribution-lines 230 in a longitudinal direction thereof to be spacedly arranged from each other. Specifically, the first auxiliary ejection-nozzles 250 may be positioned at a lower position than the first primary ejection-nozzles 240 to allow the remaining sludge not moved using the pressurized water from the first primary ejection-nozzles 240 to be transferred to the sludge discharging region 112. In this connection, tip portions of the first auxiliary ejection-nozzles 250 may be positioned at a lower position than tip portions of the first primary ejection-nozzles 240. In this connection, the first auxiliary ejection-nozzles 250 may be alternated with the first primary ejection-nozzles 240.

The second pressurized water ejection assembly 300 may have one end adjacent to the bottom of the sludge discharging region 112 of the settlement basin 100 to eject the pressurized water to the bottom of the sludge discharging region 112 of the settlement basin 100 to push the sludge from the bottom of the sludge discharging region 112 to the discharging port 120. In this connection, the second pressurized water ejection assembly 300 may include a second pump 310, a second pressurized water supply-line 320, second pressurized water distribution-lines 330, and second primary ejection-nozzles 340.

The second pump 310 may be configured to generate a conveying pressure to supply the pressurized water from an external storage to the second pressurized water supply-line 320 wherein the pressurized water may be ejected onto the bottom of the settlement basin 100, more preferably, to the bottom of the sludge discharging region 112 thereof. The second pump 310 may be provided at one side of the settlement basin 100 and may be fluid-coupled to one longitudinal end of the second pressurized water supply-line 320. In this connection, the second pump 310 may be fixedly provided outside of the settlement basin 100 or may be lifted or lowered from or to the surface of the water in the settlement basin 100. In this connection, when the second pump 310 is activated, the water to be supplied to the second pressurized water supply-line 320 may be embodied as a separate from the external storage or an upper water in the settlement basin 100.

The second pressurized water supply-line 320 may be configured to supply the pressurized water using the second pump 310 to the second pressurized water distribution-lines 330. The second pressurized water supply-line 320 may have one longitudinal end coupled to an outlet of the second pump 310, and outlets coupled to inlets of the second pressurized water distribution-lines 330.

The second pressurized water distribution-lines 330 may be branched from the second pressurized water supply-line 320 to allow the ejection of the pressurized water into the settlement basin 100. Specifically, each of the second pressurized water distribution-lines 330 may have one longitudinal end coupled to outlets of the second pressurized water supply-line 320. The second pressurized water distribution-lines 330 may have the other longitudinal ends respectively which may be arranged horizontally to be spaced from each other on the bottom of the sludge discharging region 112 of the settlement basin 100. In this connection, the second pressurized water distribution-lines 330 may be branched from the second pressurized water supply-line 320 in a longitudinal direction thereof to be spaced from each other and may be fluid-coupled to the second pressurized water supply-line 320. In this connection, it may be preferable that the second pressurized water distribution-lines 330 may have the other longitudinal ends arranged horizontally to be spaced from each other on the bottom of the sludge discharging region 112 of the settlement basin 100. The present disclosure may not be limited thereto. The second pressurized water distribution-lines 330 may be disposed on the side wall of the sludge discharging region 112. The second pressurized water distribution-lines 330 may be buried in the bottom or sidewall of the sludge discharging region 112 of the settlement basin 100 such that tip portions of the second primary ejection-nozzles 340 may protrude out of the bottom of the settlement basin 100 into the settlement basin 100. Additionally, each of the second pressurized water distribution-lines 330 may have a second adjustment valve 360 at one end thereof to control a fluid flow from the second pressurized water supply-line 320 to the second primary ejection-nozzles 340. Further, each of the second pressurized water distribution-lines 330 may have a second back pressure delay valve 370 at one end thereof, wherein the second back pressure delay valve 370 may be configured not to stop the ejection of the pressurized water from the second primary ejection-nozzles 340 immediately after the second adjustment valve 360 is closed, but to be closed in a given time after the second adjustment valve 360 is closed to prevent a back-flow of the sludge via the second primary ejection-nozzles 340. The second back pressure delay valve 370 may bypass the second adjustment valve 360 along each of the second pressurized water distribution-lines 330.

The second primary ejection-nozzles 340 may be configured to eject the pressurized water from the second pressurized water distribution-lines 330 to the bottom of the settlement basin 100, more preferably, to the bottom of the sludge discharging region 112 to transfer the sludge thereon in the sludge discharging region 112 to the discharging port 120. The second primary ejection-nozzles 340 may be spacedly arranged from each other along each of the second pressurized water distribution-lines 330 in a longitudinal direction thereof. In this connection, the tip portions of the second primary ejection-nozzles 340 may be oriented toward the discharging port 120 to eject the pressurized water toward the discharging port 120 to transfer the sludge on the bottom of the sludge discharging region 112 to the discharging port 120. Thus, when the second primary ejection-nozzles 340 ejects the pressurized water, the sludge on the bottom of the sludge discharging region 112 of the settlement basin 100 may be transferred to the discharging port 120.

The second pressurized water ejection assembly 300 may further include a plurality of second auxiliary ejection-nozzle 350 spacedly arranged from each other along each of the second pressurized water distribution-lines 330 in a longitudinal direction thereof. Specifically, the second auxiliary ejection-nozzle 350 may be located at a lower position than the second primary ejection-nozzles 340 to transfer the remaining sludge not moved using the pressurized water ejected from the second primary ejection-nozzles 340 toward the discharging port 120. In this connection, the second auxiliary ejection-nozzle 350 may be horizontally arranged under the second primary ejection-nozzles 340 and may be coupled to each of the second pressurized water distribution-lines 330. In this connection, the second auxiliary ejection-nozzle 350 may be alternated with the second primary ejection-nozzles 340 and may be coupled to each of the second pressurized water distribution-lines 330.

In this connection, the second adjustment valve 360 of the second pressurized water ejection assembly 300 may control the flow rate of the pressurized water from the second pressurized water supply-line 320 to the second pressurized water distribution-lines 330 such that the second primary ejection-nozzles 340 and the second auxiliary ejection-nozzle 350 may eject the pressurized water at a predetermined interval. As such, the second adjustment valve 360 of the second pressurized water ejection assembly 300 may control a flow rate of the pressurized water via the second primary ejection-nozzles 340 and the second auxiliary ejection-nozzle 350 to minimize the shake of the sludge on the bottom of the sludge discharging region 112 and to allow the stable transfer of the sludge to the discharging port 120.

The separation-water ejection assembly 400 may be configured to create a separation-water above the partition portion 110 of the settlement basin 100 to physically separate between the sludge conveying region 111 and the sludge discharging region 112 in the settlement basin 100. Specifically, the separation-water ejection assembly 400 may be disposed above the partition portion 110 at a predetermined distance. The separation-water ejection assembly 400 may have one end contained in the settlement basin 100 to eject the pressurized water toward the partition portion 110 when the sludge on the bottom of the sludge discharging region 112 is transferred using the second pressurized water ejection assembly 300 to the discharging port 120. Thus, the pressurized water ejected from the separation-water ejection assembly 400 may act as the separation-water between the sludge conveying region 111 and the sludge discharging region 112 to prevent the back-flow of the sludge to the sludge conveying region 111 during transferring the sludge from the sludge discharging region 112 to the discharging port 120. In this connection, the separation-water ejection assembly 400 may include a third pump 410, a third pressurized water supply-line 420, a third pressurized water distribution-line 430, third ejection-nozzles 440.

The third pump 410 may be configured to generate a conveying pressure to eject the pressurized water toward the partition portion 110 of the settlement basin 100. The third pump 410 may be provided at one side of the settlement basin 100 and may be coupled to one longitudinal end of the third pressurized water supply-line 420. In this connection, the third pump 410 may be fixedly provided out of the settlement basin 100 or may be lifted or lowered from or to the surface of the water in the settlement basin 100. In this connection, when the third pump 410 is activated, the water to be supplied as the pressurized water may be embodied as the separate water from the external storage or as an upper water in the settlement basin 100. In one embodiment, the third pump 410 may be separate. The present disclosure may not be limited thereto. In another embodiment, the third pump 410 may be embodied using one of the first and second pumps 210 and 310.

The third pressurized water supply-line 420 may be configured to guide the pressurized water using the third pump 410 to the third pressurized water distribution-line 430. The third pressurized water supply-line 420 may have one longitudinal end fluid-coupled to an outlet of the third pump 410, and the other longitudinal end coupled to an inlet of the third pressurized water distribution-line 430.

The third pressurized water distribution-line 430 may be configured to guide the pressurized water from the third pressurized water supply-line 420 to the third ejection-nozzles 440 to allow the ejection of the pressurized water toward the partition portion 110 of the settlement basin 100. Specifically, the third pressurized water distribution-line 430 may have one longitudinal end coupled to the other longitudinal end of the third pressurized water supply-line 420 and the other longitudinal end which may extend horizontally above the partition portion 110 of the settlement basin 100 at a predetermined distance. Additionally, the third pressurized water distribution-line 430 may have a third adjustment valve 450 at one end thereof to control a fluid flow from the third pressurized water supply-line 420 to the nozzles 440. To be specific, the third adjustment valve 450 may be configured to be open only when the second pressurized water ejection assembly 300 ejects the pressurized water therefrom. Further, the third pressurized water distribution-line 430 may have a third back pressure delay valve 460 at one end thereof to be configured not to stop the ejection of the pressurized water from the third ejection-nozzles 440 just after the third adjustment valve 450 is closed but to be closed in a given time after the third adjustment valve 450 is closed to prevent the back-flow of the sludge via the third ejection-nozzles 440. The third back pressure delay valve 460 may bypass the third adjustment valve 450 along the third pressurized water distribution-line 430.

The third ejection-nozzles 440 may be configured to eject the pressurized water from the third pressurized water distribution-line 430 toward the partition portion 110 of the settlement basin 100 to create the separation water wall corresponding to the line of the partition portion 110 with a vertical extension length in the settlement basin 100. The third ejection-nozzles 440 may be spacedly arranged from each other along the third pressurized water distribution-line 430 in a longitudinal direction thereof. In this connection, the tip portions of the third ejection-nozzles 440 may be oriented toward the partition portion 110 to eject the pressurized water toward the partition portion 110 and, thus, may extend downwardly from the third pressurized water distribution-line 430. Thus, when the third ejection-nozzles 440 eject the pressurized water toward the partition portion 110 of the settlement basin 100, the pressurized water may act as the separation water wall above the partition portion 110. Thus, when the third ejection-nozzles 440 eject the pressurized water, the separation water wall may physically separate between the sludge conveying region 111 of the settlement basin 100 and the sludge discharging region 112 thereof. Thus, when using the second pressurized water ejection assembly 300, the sludge is transferred to the discharging port 120, the back-flow of the sludge to the sludge conveying region 111 may be suppressed efficiently.

In one embodiment, the sludge discharging system for a settlement basin may have a flow guide plate 500 and a dead-area ejection assembly 600 in the settlement basin 100. First, the flow guide plate 500 may be provided at an inner bottom corner of the settlement basin 100. In this connection, the flow guide plate 500 may be concavely rounded at a top face thereof.

The flow guide plate 500 may be disposed at the inner bottom corner of the settlement basin 100 to allow the inner bottom corner of the settlement basin 100 to have a gentle slope to prevent the sludge from accumulating on the inner bottom corner of the settlement basin 100. In this connection, the flow guide plate 500 may be preferably fixedly installed to the inner bottom corner of the sludge conveying region 111 of the settlement basin 100. The present disclosure may not be limited thereto. the flow guide plate 500 may be provided at all of to the inner bottom corners of the settlement basin 100.

The dead-area ejection assembly 600 may be configured to eject the pressurized water to the flow guide plate 500. The dead-area ejection assembly 600 may be coupled to the first pressurized water ejection assembly 200 and receive the pressurized water from the first pressurized water ejection assembly 200. In this connection, the dead-area ejection assembly 600 may be further coupled to the second pressurized water ejection assembly 200 and receive the pressurized water from the second pressurized water ejection assembly 200 when the flow guide plate 500 is further provided at an inner bottom corner of the sludge discharging region 112. In this case, the dead-area ejection assembly 600 may eject the pressurized water to the flow guide plate 500 at the inner bottom corner of the sludge discharging region 112. The dead-area ejection assembly 600 may include a fourth water supply-line 610, and a fourth water ejection-nozzle 620.

The fourth water supply-line 610 may be coupled to the first pressurized water ejection assembly 200 and may receive the pressurized water from the ejection assembly 200. The fourth water supply-line 610 may have one longitudinal end fluid-coupled to first pressurized water supply-line 220 of the first pressurized water ejection assembly 200, and the other longitudinal end fixed to a side wall of the settlement basin 100. In this connection, the other longitudinal end of the fourth water supply-line 610 may be disposed above the flow guide plate 500 and fixed to a side wall of the settlement basin 100 in the sludge conveying region 111. In this connection, when multiple flow guide plates 500 are provided in the settlement basin 100, the fourth water supply-line 610 may be plural to be disposed above each of the flow guide plates 500. In this connection, when the flow guide plate 500 is provided at the inner bottom corner of the bottom of the sludge discharging region 112 of the settlement basin 100, one longitudinal end of the fourth water supply-line 610 may be fluid-coupled to the second pressurized water supply-line 320 of the second pressurized water ejection assembly 200.

The fourth water ejection-nozzle 620 may eject the pressurized water from the fourth water supply-line 610 toward the flow guide plate 500 to move the sludge on the inner bottom corner of the settlement basin 100. Specifically, the fourth water ejection-nozzle 620 may eject the pressurized water suppled via the fourth water supply-line 610 from the first pressurized water supply-line 220 of the first pressurized water ejection assembly 200 toward the flow guide plate 500 at the inner bottom portion of the sludge conveying region 111 to move the sludge settled on the inner bottom portion of the sludge conveying region 111 to the sludge discharging region 112. The fourth water ejection-nozzles 620 may be spacedly arranged along the fourth water supply-line 610 in a longitudinal direction thereof. The fourth water ejection-nozzle 620 may have a tip portion oriented toward the flow guide plate 500.

Hereinafter, a discharging operation of the above-defined sludge discharging system for a settlement basin will be described. First, the first pressurized water ejection assembly 200 may move the sludge on the bottom of the sludge conveying region 111 of the settlement basin 100 toward the sludge discharging region 112. Specifically, the activation of the first pump 210 of the first pressurized water ejection assembly 200 may supply the first pressurized water via the first pressurized water supply-line 220 and the first pressurized water distribution-lines 230 to the first primary ejection-nozzles 240. Then, the first primary ejection-nozzles 240 may eject the first pressurized water to the sludge on the bottom of the sludge conveying region 111 toward the sludge discharging region 112. Thus, the sludge in the sludge conveying region 111 may be transferred to the sludge discharging region 112.

Thereafter, the second pressurized water ejection assembly 300 may move the sludge on the bottom of the sludge discharging region 112 of the settlement basin 100 toward the discharging port 120. Specifically, the activation of the second pump 310 of the second pressurized water ejection assembly 300 may supply the second pressurized water via the second pressurized water supply-line 320 and the second pressurized water distribution-lines 330 to the second primary ejection-nozzles 340. Then, the second primary ejection-nozzles 340 may eject the second pressurized water to the sludge on the bottom of the sludge discharging region 112 toward the discharging port 120. Thus, the sludge in the sludge discharging region 112 may be discharged via the discharging port 120 out of the basin 100.

In this connection, while the second pressurized water ejection assembly 300 may eject the second pressurized water to the sludge on the bottom in the sludge discharging region 112, the separation-water ejection assembly 400 may eject the third pressurized water toward the partition portion between the sludge conveying region 111 of the settlement basin 100 and the sludge discharging region 112 thereof to form the separation water wall therebetween. Specifically, the activation of the third pump 410 of the separation-water ejection assembly 400 may supply the third pressurized water via the third pressurized water supply-line 420 and the third pressurized water distribution-line 430 to the third ejection-nozzles 440. Then, the third ejection-nozzles 440 may eject the third pressurized water toward the partition portion 110 to form the separation water wall between the sludge conveying region 111 and the sludge discharging region 112 thereof. Thus, while the second pressurized water ejection assembly 300 ejects the second pressurized water to the sludge on the bottom in the sludge discharging region 112 toward the discharging port 120, the back-flow of the sludge from the sludge discharging region 112 to the sludge conveying region 111 may be suppressed by the separation water wall, thereby to lead to a reliable sludge discharging operation out of the settlement basin 100.

The present sludge discharging system for a settlement basin may have the partition portion 110 between the sludge conveying region 111 and sludge discharging region 112 on the bottom of the settlement basin. The first pressurized water ejection assembly 200 may move the sludge from the sludge conveying region to the sludge discharging region. The second pressurized water ejection assembly may 300 move the sludge from the sludge discharging region 112 to the discharging port 120 out of the settlement basin 100. In this connection, the separation-water ejection assembly 400 may form a separation water wall above the partition portion 110 to suppress the back-flow of the sludge to the sludge conveying region 111 during the second pressurized water ejection assembly 300 moves the sludge to the discharging port 120. This may achieve a reliable sludge discharging operation.

Although the present invention has been described with reference to the embodiment illustrated in the drawings, the embodiment is merely illustrative, and those skilled in the art would appreciate that various modifications and other equivalent embodiments are possible. Therefore, the true technical scope of protection of the present invention should be defined by the technical concept of the appended claims.

### REFERENCE NUMERALS

100: settlement basin
110: partition portion
111: sludge conveying region
112: sludge discharging region
120: discharging port
200: first pressurized water ejection assembly
300: second pressurized water ejection assembly
210: first pump
220: first pressurized water supply-lines
230: first pressurized water distribution-line
240: first ejection-nozzles
250: first auxiliary ejection-nozzle
300: second pressurized water ejection assembly
310: second pump
320: second pressurized water supply-lines
330: second pressurized water distribution-line
340: second ejection-nozzle
350: second auxiliary ejection-nozzle
400: separation-water ejection assembly
410: third pump
420: third pressurized water supply-line
430: third pressurized water distribution-line
440: third ejection-nozzle

1. A sludge discharging system for a settlement basin, the system comprising:
a settlement basin having a partition portion upwardly protruded on a bottom thereof, wherein the partition portion dividing the settlement basin into a sludge conveying region and a sludge discharging region, wherein the settlement basin has a discharging port defined at one side wall thereof in the sludge discharging region;
a first pressurized water ejection assembly having a water ejection portion adjacent to a bottom of the basin in the sludge conveying region to eject a first pressurized water to a sludge on the bottom of the basin in the sludge conveying region to move the sludge from the sludge conveying region to the sludge discharging region;
a second pressurized water ejection assembly having a water ejection portion adjacent to a bottom of the basin in the sludge discharging region to eject a second pressurized water to a sludge on the bottom of the basin in the sludge discharging region to move the sludge to the discharging port; and
a separation-water ejection assembly having a water ejection portion disposed above the partition portion to eject a third pressurized water toward the partition portion when the sludge in the sludge discharging region is discharged to the port using the second pressurized water ejection assembly, wherein the ejection of the third pressurized water forms a separation water wall between the sludge conveying region and the sludge discharging region, to prevent a back-flow of the sludge from the sludge discharging region to the sludge conveying region.

2. The system of claim 1, wherein the first pressurized water ejection assembly includes:
a first pump;
a first pressurized water supply-line fluid-coupled to the first pump to receive the first pressurized water pressurized using the first pump;
first pressurized water distribution-lines, each line having one end fluid-coupled to the first pressurized water supply-line, the other ends of the first pressurized water distribution-lines being horizontally spacedly arranged on the bottom of the basin in the sludge conveying region; and
first primary ejection-nozzles fluid-coupled to each of the first pressurized water distribution-lines, the first ejection-nozzles being spacedly arranged from each other in a longitudinal direction of the other end of each first pressurized water distribution-line, wherein the first ejection-nozzles eject the first pressurized water toward the sludge discharging region to move the sludge to the sludge discharging region.

3. The system of claim 2, wherein the first pressurized water ejection assembly further includes:
a first adjustment valve coupled to one end of each of the first pressurized water distribution-lines; and
a first back pressure delay valve coupled to one end of each of the first pressurized water distribution-lines so as to bypass the first adjustment valve.

4. The system of claim 2, wherein the first ejection-nozzles are arranged horizontally on the bottom of the basin in the sludge conveying region, wherein the first assembly further includes first auxiliary ejection-nozzles fluid-coupled to each of the first pressurized water distribution-lines, the first auxiliary ejection-nozzles being horizontally spacedly arranged from each other in a longitudinal direction of the other end of each first pressurized water distribution-line, wherein the first auxiliary ejection-nozzles are disposed under the first primary ejection-nozzles.

5. The system of claim 4, wherein the first auxiliary ejection-nozzles are alternated in a position with the first ejection-nozzles.

6. The system of claim 1, wherein the second pressurized water ejection assembly includes:
a second pump;
a second pressurized water supply-line fluid-coupled to the second pump to receive the second pressurized water pressurized using the second pump;
second pressurized water distribution-lines, each line having one end fluid-coupled to the second pressurized water supply-line, the other ends of the second pressurized water distribution-lines being horizontally spacedly arranged on the bottom of the basin in the sludge discharging region; and
second primary ejection-nozzles fluid-coupled to each of the second pressurized water distribution-lines, the second ejection-nozzles being spacedly arranged from each other in a longitudinal direction of the other end of each second pressurized water distribution-line, wherein the second ejection-nozzles eject the second pressurized water toward the discharging port to move the sludge to the discharging port.

7. The system of claim 6, wherein the second pressurized water ejection assembly further includes:
a second adjustment valve coupled to one end of each of the second pressurized water distribution-lines; and
a second back pressure delay valve coupled to one end of each of the second pressurized water distribution-lines so as to bypass the second adjustment valve.

8. The system of claim 6, wherein the second ejection-nozzles are arranged horizontally on the bottom of the basin in the sludge discharging region, wherein the second assembly further includes second auxiliary ejection-nozzles fluid-coupled to each of the second pressurized water distribution-lines, the second auxiliary ejection-nozzles being horizontally spacedly arranged from each other in a longitudinal direction of the other end of each second pressurized water distribution-line, wherein the second auxiliary ejection-nozzles are disposed under the second primary ejection-nozzles.

9. The system of claim 8, wherein the second auxiliary ejection-nozzles are alternated in a position with the second ejection-nozzles.

10. The system of claim 1, wherein the separation-water ejection assembly includes:
a third pump;
a third pressurized water supply-line fluid-coupled to the third pump to receive the third pressurized water pressurized using the third pump;
a third pressurized water distribution-line parallel to the partition portion and disposed above the partition portion at a predetermined distance, the third pressurized water distribution-line having one end fluid-coupled to the third pressurized water supply-line; and
third ejection-nozzles fluid-coupled to the third pressurized water distribution-line and spacedly arranged from each other along a longitudinal direction of the third pressurized water distribution-line, wherein the third ejection-nozzles eject the third pressurized water toward the partition portion to form the separation water wall between the sludge conveying region and the sludge discharging region.

11. The system of claim 10, wherein the third pressurized water ejection assembly further includes:
a third adjustment valve coupled to one end of the third pressurized water distribution-line; and
a third back pressure delay valve coupled to one end of the third pressurized water distribution-line so as to bypass the third adjustment valve.

12. The system of claim 1, wherein the partition portion has a triangular cross section shape, wherein the partition portion has an apex, a first tilt angle from a horizontal plane tangential to the apex to a first side face of the partition portion toward the sludge discharging region, and a second tilt angle from the horizontal plane tangential to the apex to a second side face of the partition portion toward the sludge conveying region wherein the first tilt angle is larger than the second tilt angle.

13. The system of claim 12, wherein the second side face of the partition portion toward the sludge conveying region is rounded.

14. The system of claim 1, further comprising:
a flow guide plate provided at one or more of four inner bottom corners of the basin in the sludge conveying region, wherein the flow guide plate has a concavely rounded top face; and
a dead-area ejection assembly fluid-coupled to the first pressurized water ejection assembly to eject the first pressurized water to the flow guide plate.

15. The system of claim 14, wherein the dead-area ejection assembly includes:
a fourth water supply-line having one end fluid-coupled to the first pressurized water ejection assembly and the other end coupled to a side wall of the settlement basin in the sludge conveying region and disposed above the flow guide plat; and
fourth water ejection-nozzles spacedly arranged from each other along the fourth water supply-line in a longitudinal direction thereof, wherein the fourth water ejection-nozzles eject the first pressurized water from the first pressurized water ejection assembly to the flow guide plate to move the sludge on the inner bottom corner of the basin in the sludge conveying region to the sludge discharging region.
